(19) United States
(12) Patent Application Publication
(10) Pub. No.: US 2005/0074203 A1
(43) Pub. Date: Apr. 7, 2005

(54) Device for multiplexing an array of optical channels, use for wavelength and add-drop multiplexing

(76) Inventor: Francois Marion, St Egreve (FR)

Correspondence Address: Thelen Reid & Priest, PO Box 640640, San Jose, CA, 95164-0640, US

(21) Appl. No.: 10/496,354

(22) PCT Filed: Nov. 27, 2002
(86) PCT No.: PCT/FR02/04069

(30) Foreign Application Priority Data
Nov. 29, 2001 (FR) 01/15440

(51) Int. Cl. G02B 6/26

(52) U.S. Cl. 385/24; 385/48

(57) ABSTRACT

Device for multiplexing a matrix of optical channels, application to wavelength division multiplexing and add-drop.

This device comprises N plane optical wave guides (16), each being capable of multiplexing M channels to 1 channel, where M>1 and N>1, the set of N wave guides thus being capable of multiplexing M×N channels to N first channels, and a complementary plane optical wave guide (24) capable of multiplexing N second channels to at least one coupling channel, these N second channels being optically coupled to the N first channels respectively.

### TECHNICAL DOMAIN

This invention relates to a device for multiplexing a matrix of optical channels.

It is particularly applicable to wavelength division multiplexing devices and to add-drop devices.

More generally, the invention is applicable to the domain of optoelectronics assembly.

### STATE OF PRIOR ART

It is known how to combine several optical signals with different wavelengths in a single optical fibre.

To achieve this, it is known how to use a laser emitter for each wavelength, this laser being optically coupled to an optical fibre, and to multiplex the different optical fibres for example by melting (to form Fused Biconic Tapered (FBT) couplers), or by combination in plane wave guides.

FIG. 1 is a diagrammatic view of a known device for multiplexing several optical signals.

This known device comprises a silicon substrate (2) into in which V grooves are formed. The ends of the optical fibres 4 are fixed in these grooves. The optical signals that are to be multiplexed propagate in these optical fibres.

The device in FIG. 1 also comprises a plane optical coupling wave guide 6 comprising the same number of inputs as the number of optical fibres, and one output. These inputs are optically coupled to the ends of optical fibres fixed in grooves in the silicon substrate. This plane optical wave guide 6 multiplexes optical signals that propagate in the fibres, these signals thus being located at the output from the plane optical wave guide.

The device in FIG. 1 also comprises another silicon substrate 8 provided with a V groove in which the end of another optical fibre 10 is fixed. This end is optically coupled to the output from the plane optical wave guide such that the optical signals that were multiplexed by means of the plane optical wave guide 6 propagate in the output optical fibre 10.

It is also known how to do such coupling using a cascade assembly of optical fibres. Further information about this subject is given in document:
(1) U.S. Pat. No. 5,809,190 A (Chen).

Known multiplexing techniques are very complex to implement. Moreover, for example, the fusion technique mentioned above can couple a matrix of light detectors with an optical fibre, but the device obtained is large because this device uses a link consisting of pairs of optical fibres in series, each being coupled to an input emitter.

Moreover, the technique using the plane optical wave guide is incapable of coupling a matrix of light emitters in an optical wave guide without using a set of optical fibres. This technique only enables coupling in the plane of the multiplexing optical wave guide.

Presentation of the Invention

The purpose of this invention is to overcome the above-mentioned disadvantages.

This invention provides a means of multiplexing optical channels arranged in a matrix layout using an extremely compact device.

Furthermore, the invention provides a means of coupling and multiplexing light beams emitted by a matrix of lasers (for example a matrix of vertical cavity surface emitting lasers VCSEL) with a single optical fibre, using a technique that does not make use of intermediate optical fibres.

Further information about manufacturing a matrix of VCSELs with variable wavelengths is given in document:
(2) EP 0 949728 A.

Moreover, the device according to the invention is much easier to make than the device in FIG. 1 and devices known according to document (1).

The invention has the advantage that it is easy to couple a matrix of light detectors and an optical fibre, much more compactly than with the fusion technique mentioned above.

The invention also provides a means of eliminating optical fibres between the matrix of light emitters and the output optical fibre and only using optical circuits formed by plane optical wave guides to multiplex the input optical signals.

Specifically, the purpose of this invention is a device for multiplexing a matrix of M×N optical channels to at least one channel, where M and N are integer numbers greater than 1 (M>1 and N>1), this device being characterised in that it comprises:
N plane optical wave guides, each being capable of multiplexing M channels to 1 channel, the set of N wave guides thus being capable of multiplexing M×N channels to N first channels, and
a complementary plane optical wave guide capable of multiplexing N second channels to at least one coupling channel, these N second channels being optically coupled to the first N channels respectively.

According to one preferred embodiment of the device according to the invention, the N plane optical wave guides are placed adjacent to each other, the first N channels are aligned and the complementary plane optical wave guide is perpendicular to the N adjacent plane optical wave guides.

According to a particular embodiment of the device according to the invention, this device also comprises a matrix of M×N light emitters and/or detectors that are optically coupled to the M×N channels.

The M×N light emitters and/or detectors may include lasers.

For example, these lasers may be VCSELs (vertical cavity surface emitting lasers).

Emission and/or detection wavelengths of light emitters and/or detectors may be different.

According to one particular embodiment of the device according to the invention, this device also comprises at least one flexible optical wave guide optically coupled to the coupling channel of the device.

This flexible optical wave guide may be an optical fibre.

The invention also relates to a wavelength division multiplexing device comprising a multiplexing device according to the invention.

The invention also relates to an add-drop device comprising:
an input device that will receive optical input signals and that includes a first multiplexing device according to the invention and a matrix of light detectors optically coupled to the channels of the first multiplexing device, to convert optical input signals into electrical signals in order to extract at least one electrical signal from them, and
an output device comprising a second multiplexing device according to the invention and a matrix of light emitters optically coupled to the channels of the second multiplexing device to convert unextracted electrical signals into optical output signals and to insert at least one optical signal into these output optical signals.

### BRIEF DESCRIPTION OF THE DRAWINGS

This invention will be better understood after reading the following description of example embodiments given for guidance only and in no way limitative, with reference to the appended drawings among which:

FIG. 1 is a diagrammatic view of a known multiplexing device and has already been described,

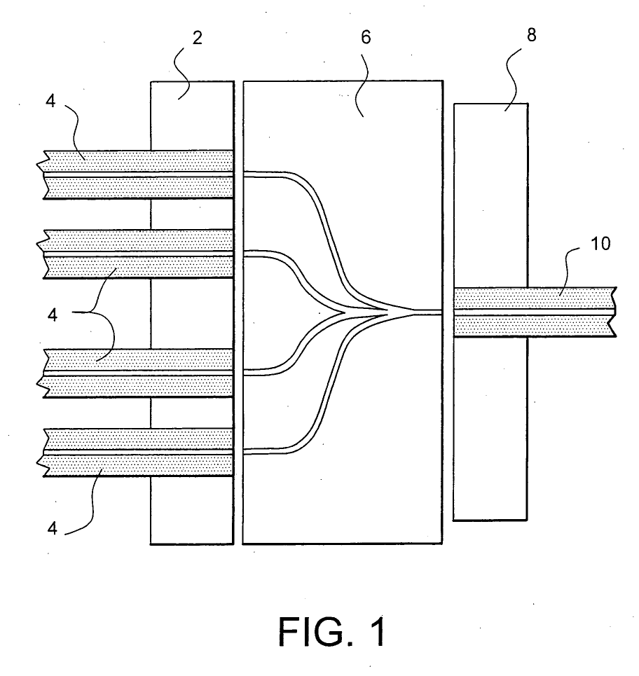

FIG. 2 is an exploded diagrammatic perspective view of a particular embodiment of the multiplexing device according to the invention, and

FIG. 3 is a diagrammatic view of an add-drop device using this invention.

### DETAILED PRESENTATION OF PARTICULAR EMBODIMENTS

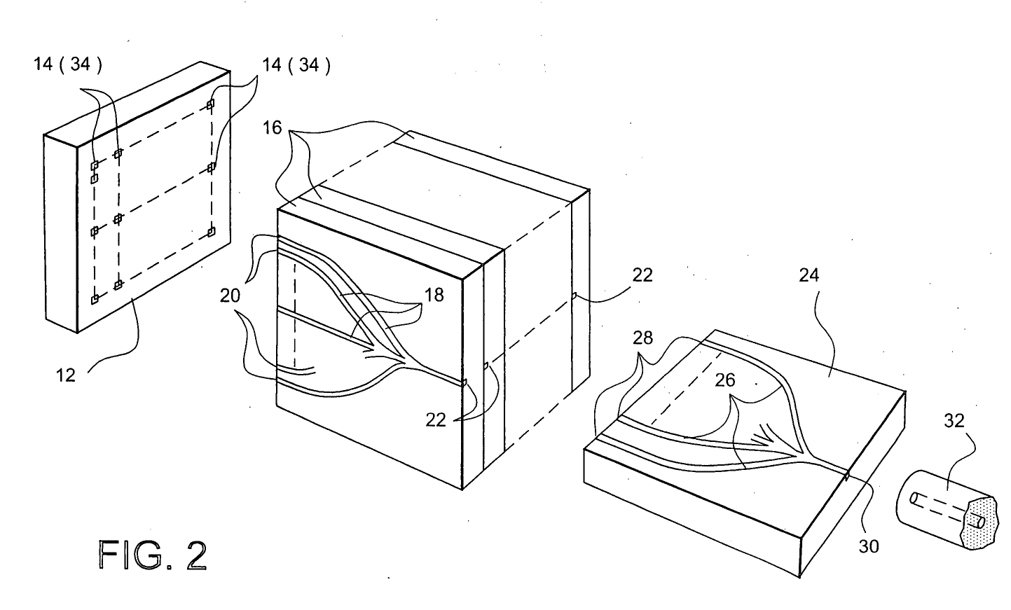

The device according to the invention that is diagrammatically shown in the exploded perspective in FIG. 2, comprises a matrix of M×N lasers, preferably a matrix of M×N VCSELs that emit at different wavelengths. This matrix comprises M rows and N columns, where M>1 and N>1.

The device also comprises a set of N adjacent plane optical wave guides 16. Each of these plane wave guides comprises M planar guides enabling planar multiplexing of M inputs 20 to one output 22.

The N plane optical wave guides 16 are aligned and stacked such that each of the M×N inputs 20 of the set of these plane optical wave guides 16 is optically aligned with one of the light emitting lasers 14 to be optically coupled with this laser.

Furthermore, the device in FIG. 2 is made such that the N outputs 22 from the set of N plane optical wave guides 16 are aligned with each other, with a perfectly known spacing between them.

The device in FIG. 2 also comprises another plane optical wave guide 24 that comprises N planar guides 26 enabling planar multiplexing of N inputs 28 to one output 30. This other plane optical wave guide 24 is arranged perpendicular to the wave guide 16 and is built such that these N inputs 28 are perfectly aligned with the N aligned outputs 22 of the N plane optical wave guides 16 to be optically coupled with these outputs.

The device in FIG. 2 also comprises a flexible output optical wave guide that may for example be an optical fibre 32.

One end of this fibre 32 is optically coupled to the output 30 from the plane optical wave guide 24 so as to retrieve the optical signal which is supplied through this output 30 and is the result of multiplexing the optical signals supplied by the lasers 14.

Therefore, the device in FIG. 2 provides a means of coupling several plane optical wave guides parallel to each other so as to have aligned optical outputs and to multiplex the created line with another plane optical wave guide placed perpendicular to the first.

The matrix 12 of light emitting lasers 14 may be replaced by a matrix of photo detectors 34.

In this case, the device in FIG. 2 can be used to send light propagating in the optical fibre 32 to these photo detectors 34 passing through the plane optical wave guide 24 and the plane optical wave guides 16 in the stack (according to the inverse light return principle) and references 22 and 30 in FIG. 2 correspond to inputs while references 20 and 28 correspond to outputs.

As a variant, the matrix 12 may be a set of light emitters—receivers capable of receiving light signals propagating in the optical fibre 32 and sending optical signals in the optical fibre 32 that are multiplexed using the device in FIG. 2.

Moreover, instead of having a single output 30, the plane optical wave guide 24 may comprise two or more than two outputs. In this case, one flexible optical wave guide is used for each output and one end of each flexible optical wave guide is optically coupled to one of these outputs.

For guidance only and in no way limitatively, it is assumed that there are 64 digital signals generated by an integrated circuit. It is required to transmit these signals on a single optical fibre at a rate of 2.5 Gbits/s per signal (aggregate rate equal to 160 Gb/s), to another integrated circuit at a distance of 300 m. A multiplexing device according to the invention is then made.

This is done by firstly making a CMOS integrated circuit with a hybridised multi-frequency matrix of VCSELs. For example, this multi-frequency matrix of VCSELs is made e.g. using the technique described in document (2) mentioned above, in the form of a matrix of VCSELs with a variable cavity length.

The pitch between these VCSELs is equal to 250 μm, the frequency spacing is equal to 50 GHz (0.4 nm) and the size of the emission circuit is equal to about 3 mm×3 mm.

A single type of optical integrated circuit is used for multiplexing, namely a plane “8 to 1” multiplexing circuit with a pitch of 250 μm.

A stack of 8 optical circuits of this type is made with a pitch of 250 μm between the planes of these circuits and the block thus obtained is aligned and is then fixed to the light emission matrix.

Furthermore, the same type of optical circuit is aligned with the 8 block outputs at a pitch of 250 μm, and this circuit is then fixed to this block.

An optical fibre is then aligned and then fixed with respect to the output of this circuit. This is done for example by using a substrate comprising a V groove in which one end of the fibre is fixed.

Note that for manufacturing of a multiplexing device according to the invention, it is known how to manufacture plane multiplexing optical wave guides of the “M to 1” type on glass substrates. Control over the cut-outs of these wave guides to the nearest micrometer makes it possible to use wave guides with perfectly controlled dimensions.

The stack of N of these wave guides edge to edge provides a means of mechanically aligning them and fixing them to make a multiplexing block of the “M×N to N” type.

Another block with the same outside dimensions could also be made comprising an “N to 1” type plane optical wave guide, and the two blocks could then be aligned and mechanically fixed edge to edge to obtain a device according to the invention.

We have already described an example application of the invention to wavelength division multiplexing with reference to FIG. 2.

We will now consider another example application of the invention to manufacturing an add-drop device.

It is known that one very important function in optical circuits field is the add-drop function, for which further information can be obtained for example in the following document:
(3) M. Carlson, DWDM Technology, fibre Systems Europe, March 2001, page 68.

It is easy to make a fully “dynamic” add-drop circuit (possible choice of the wavelength to be extracted and inserted) starting from this invention.

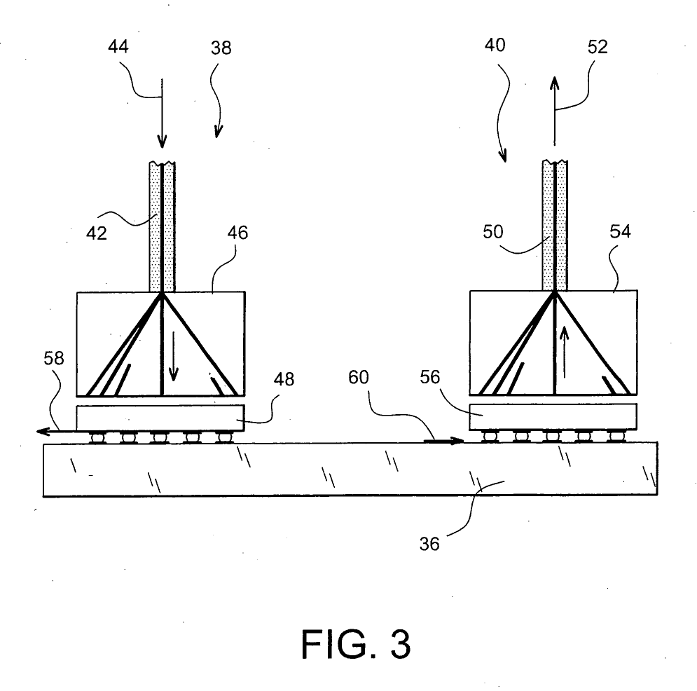

This is diagrammatically illustrated in FIG. 3 which shows an add-drop device according to the invention.

This device comprises an integrated control circuit 36 that will process and amplify the various electrical signals generated in the device, a part 38 for demultiplexing optical signals and a part 40 for multiplexing optical signals.

The demultiplexing part 38 comprises an input optical fibre that transmits optical signals 44 with the different wavelengths λ1, λ2 . . . λn, a demultiplexing block 46 and a multispectral detection circuit 48.

The demultiplexing block 46 is optically coupled at one end to the input optical fibre 42, and at the other end to the multispectral detection circuit 48. The multispectral detection circuit is also electrically connected to the integrated control circuit 36 through solder balls.

The multiplexing part 40 comprises an optical output fibre 50 designed to transmit optical signals 52 with different wavelengths λ1, λ2 . . . λn, a multiplexing block 54 and a multispectral emission circuit 56.

The multiplexing block 54 is optically coupled at one end to the output optical fibre 52, and at the other end to the multispectral emission circuit 56. The multispectral emission circuit is also electrically connected to the control integrated circuit 36 through solder balls.

The demultiplexing block 46 and the multiplexing block 54 are devices according to the invention, that are composed as explained in the description of FIG. 2 and thus comprise an assembly of plane optical wave guides with an input or output channel at one end, and a set of output or input channels at the other end.

More precisely, the demultiplexing block 46 comprises an input channel optically coupled to the input optical fibre 42 at one end, and a set of output channels optically coupled to the photo detectors included in the multispectral detection circuit 48 at the other end.

The multiplexing block comprises an output channel optically coupled to the output optical fibre 50 at one end, and a set of input channels optically coupled to light emitters in the multispectral emission circuit 56 at the other end.

This multispectral detection circuit 48 comprises a matrix of photo detectors with variable wavelength cavities. For example, the document (2) mentioned above could be referred to on this subject.

The input composite signal formed by the set of signals 44 is decomposed into its different wavelengths using the circuit 48 and the demodulated signal(s) to be extracted can then be chosen, for example the signal 58 corresponding to the wavelength λ1.

The demodulated and amplified electrical signals 60 that are to be kept and that correspond to wavelengths λ2 . . . , λn, are sent through the integrated control circuit 36 to the multispectral emission circuit 56.

The signal that is to be added to replace the extracted signal is also sent (in electrical form) to the emitter with the chosen wavelength, λ1 in the example considered.

Note that the multispectral emission circuit 56 comprises a matrix of photo emitters with variable wavelength cavities (see also document (2) mentioned above). The demodulated and amplified electrical signals to be kept are sent to this matrix of emitters.

The recomposed optical signal is directed to the output optical fibre 50. This fibre 50 may form part of a ring network along which there are other add-drop devices.

1. Device for multiplexing a matrix of M×N optical channels to at least one channel, where M and N are integer numbers greater than 1, this device being characterised in that it comprises:
N plane optical wave guides (16), each being capable of multiplexing M channels to 1 channel, the set of N wave guides thus being capable of multiplexing M×N channels to N first channels, and
a complementary plane optical wave guide (24) capable of multiplexing N second channels to at least one coupling channel, these N second channels being optically coupled to the first N channels respectively.

2. Device according to claim 1, in which the N plane optical wave guides (16) are placed adjacent to each other, the N first channels are aligned and the complementary plane optical wave guide (24) is perpendicular to the N adjacent plane optical wave guides.

3. Device according to claim 1, also comprising a matrix (12) of M×N light emitters and/or detectors (14, 34) that are optically coupled to the M×N channels.

4. Device according to claim 3, in which the M×N light emitters and/or detectors (14, 34) include lasers.

5. Device according to claim 4, in which the lasers (14, 34) are vertical cavity surface emitting lasers.

6. Device according to claim 3, in which emission and/or detection wavelengths of the light emitters and/or detectors (14, 34) are different.

7. Device according to claim 1, also comprising at least one flexible optical wave guide (32) optically coupled to the coupling channel.

8. Device according to claim 7, in which the flexible optical wave guide is an optical fibre (32).

9. Wavelength division multiplexing device comprising a device according to claim 1.

10. Add-drop device comprising:
an input device (38) that will receive optical input signals (44) and including a first multiplexing device (46) according to claim 1 and a matrix (48) of light detectors optically coupled to the channels of the first multiplexing device (46), to convert the optical input signals into electrical signals in order to extract at least one electrical signal (58) from them, and
an output device (40) comprising a second multiplexing device (54) according to claim 1 and a matrix (56) of light emitters optically coupled to the channels of the second multiplexing device (54) to convert unextracted electrical signals into optical output signals and to insert at least one optical signal into these output optical signals.
